(19) United States
(12) Patent Application Publication
(10) Pub. No.: US 2001/0033638 A1
(43) Pub. Date: Oct. 25, 2001

(54) Image acquisition method and apparatus

(76) Inventor: Hitoshi Inoue, Kanagawa (JP)

Correspondence Address: MORGAN & FINNEGAN, L.L.P., 345 Park Avenue, New York, NY, 10154-0053, US

(21) Appl. No.: 09/773,095

(22) Filed: Jan. 31, 2001

(30) Foreign Application Priority Data
Feb. 4, 2000 (JP) 2000-028161
Feb. 4, 2000 (JP) 2000-028207

(51) Int. Cl. G21K 1/00

(52) U.S. Cl. 378/154; 378/98.8

(57) ABSTRACT

It is an object of this invention to provide an image acquisition apparatus which can acquire an image which prevents a stripe pattern originating from a scattered ray removing grid from interfering with observation when X-rays are radiated by using the scattered ray removing grid. An image acquisition apparatus of the invention radiates X-rays by using a scattered ray removing grid (11) and two-dimensionally samples an X-ray transmission distribution on an object (2) to be imaged at desired sampling intervals. This apparatus includes an image acquisition means for acquiring an image by setting the intervals of elements of the scattered ray removing grid, without moving the scattered ray removing grid, such that the spatial frequency of a stripe pattern, in the image, which originates from the scattered ray removing grid becomes 40% or more of a sampling frequency that is the reciprocal of the sampling intervals.

### FIELD OF THE INVENTION

The present invention relates to an image acquisition technique and, more particularly, to an image acquisition apparatus for acquiring an image corresponding to an X-ray transmission distribution obtained on an object.

### BACKGROUND OF THE INVENTION

With the recent trend toward the digitization of medical X-ray images, X-ray intensity spatial distributions can be acquired as digital images. For example, currently available schemes include a scheme of forming a latent image on a photostimulable phosphor by using X-ray energy and acquiring an image from a laser pumping light distribution, a scheme of converting an X-ray intensity distribution into a light intensity distribution (fluorescence), directly converting the distribution into an electrical signal by using a surface center having a plurality of pixels, and converting the signal into a digital image, and a scheme of directly converting an X-ray intensity distribution into a charge distribution.

The digitization of X-ray images has the following merits:

Storage and transfer can be efficiently performed.

Optimal images can be easily formed by digital image processing (a recovery from a failure in imaging operation can be made).

Efficient diagnosis can be carried out.

A reduction in the cost of diagnosis can be attained.

The problem of scattered X-rays produced when X-rays pass through an object has not been satisfactorily solved.

To reduce the influences of scattered X-rays and obtain a high-contrast image, an optimal means is to use a scattered ray removing grid having many lead plates arranged in the same direction as in a conventional scheme using silver-halide films.

FIG. 10 is a schematic sectional view of a structure using a grid. Reference numeral 81 denotes a point (X-ray focal point) of an X-ray tube from which X-rays are generated; 82, an object; 83, a grid; 84, an energy conversion unit for converting an X-ray intensity distribution into a light intensity or charge amount; and 85, a sensor unit for spatially sampling the distribution. Scattered X-rays reflected by the object reach the grid 83 as well as X-rays directly emitted from the X-ray tube. Most of the scattered X-rays are cut by the grid 83 made up of lead members facing the X-ray focal point 81.

A drawback of the grid 83 is that it partly cuts direct X-rays while it cuts scattered X-rays. This cutting pattern corresponds to the arrangement of the lead members of the grid, and the image generally suffers a stripe pattern. An X-ray image has evolved into (1) an image formed by a film-screen system (analog image)→(2) a digital image formed by reading a latent image formed by a photostimulable phosphor by laser scanning→(3) an image formed by direct sampling (flat panel sensor) the two-dimensional spatial distribution of an X-ray dose in a two-dimensional space. Different measures have therefore been taken against a stripe pattern (grid image) on an image which originates from the lead members used for the grid 83.

In the film-screen system in (1), the following two methods are available, which are used to remove a grid image or prevent interference with observation.

(a) The grid itself is moved during radiation of X-rays to prevent the formation of a grid image while removing scattered rays.

(b) The spatial frequency of the grid stripe pattern is increased to make it difficult for the human eye to perceive a grid image if it is formed on an image or prevent the grid image from overlapping the frequency component of image information.

The means of moving the grid itself in (a) is effective in all cases of X-ray image acquisition. However, this means is difficult to use because of an increase in cost due to, for example, a driving system for moving the grid, an increase in apparatus size, the relationship between the driving timing and the X-ray radiation timing, adjustment of the driving speed, and the like.

The means of increasing the spatial frequency of the grid stripe pattern in (b) has its own limit. That is, when the frequency of the grid stripe pattern is set to a high spatial frequency at which no grid image is formed, since the thickness of each lead plate for blocking scattered rays is almost fixed, an area through which direct rays are transmitted narrows, and the use efficiency of the X-ray dose extremely decreases. As a consequence, imaging operation cannot be properly performed.

In the era in which a latent image formed by a photostimulable phosphor was read by laser scanning and digitized, the idea of using anti-aliasing filter before sampling was introduced as a method of removing a grid image. When a latent image formed by a photostimulable phosphor is to be read by laser scanning and digitized, the image is scanned in a one-dimensional direction by a laser to temporarily form a signal form like a video signal, and the signal is sampled on the time axis. The frequency of the grid stripe pattern is increased to a certain degree, and laser scanning is performed in a direction perpendicular to the grid stripe pattern to form the grid stripe pattern into a periodic signal on the video signal. A grid image can be removed by the general idea of using an anti-aliasing filter, i.e., performing sampling on the time axis after low-pass filtering in the state of an analog signal as this video signal. A similar method is disclosed in Japanese Patent No. 2507659, in which a grid image and its frequency are obtained by Fourier transformation of an image obtained by preliminary sampling, and a low-pass filter corresponding to the result is selected to remove a grid image.

According to another method, sampling is performed on the time axis at intervals shorter than desired intervals instead of performing analog low-pass filtering to eliminate aliasing of grid stripe pattern information, and the resultant information is separated from image information. Thereafter, digital low-pass filtering is performed, and the resultant image is digitally decimated (sub-sampled), thereby obtaining an image at the desired sampling intervals. Similar methods are disclosed in Japanese Patent No. 2754068 and Japanese Patent Laid-Open No. 8-088765.

In the advanced era in which a digital X-ray image can be obtained by directly sampling (using a flat panel sensor) a two-dimensional spatial distribution of an X-ray dose in (3) in a two-dimensional space, the above anti-aliasing filtering cannot be used. That is, a flat panel sensor is made up of a plurality of semiconductor pixels, and the two-dimensional spatial sampling pitch of the sensor cannot be reduced more than necessary in consideration of technique and cost. The above idea of using an anti-aliasing filter cannot be applied to this method. The method disclosed in Japanese Patent Laid-Open No. 9-75332 is aimed at removing grid stripe pattern information in contrast to the method of obtaining an X-ray image by direct sampling in a two-dimensional space. In this method, the intervals of grid lead members are perfectly matched with the sampling pitch to match areas where direct X-rays are blocked by the grid stripe pattern with the gaps between the pixels, thereby preventing a grid stripe pattern from appearing on an image.

Japanese Patent Laid-Open No. 9-78970 and U.S. Pat. No. 5,801,385 disclose methods of setting the grid lead member intervals to be smaller than the sampling pitch and equal to or near the width of the opening of a light-receiving portion of one pixel, thereby reducing the contrast of a grid stripe pattern. In the method disclosed in U.S. Pat. No. 5,050,198, a grid image is input and stored under a plurality of conditions. When imaging operation is actually performed by using the grid, the obtained image is divided by a grid image of the stored grid images which corresponds to the condition under which the actual imaging operation is performed, thereby removing the grid image.

In the method disclosed in Japanese Patent Laid-Open No. 9-75332, which corresponds to the above technique of obtaining a digital X-ray image by direct sampling in a two-dimensional space using a flat panel in the two-dimensional space, it is very difficult to perfectly match the grid lead member intervals with the sampling pitch. In the methods disclosed in Japanese Patent Laid-Open No. 9-78970 and U.S. Pat. No. 5,801,385, a grid image can be effectively removed by reducing the grid lead member intervals below the sampling pitch to be equal or near the width of the opening of a light-receiving portion of one pixel. However, as the flat panel sensor increases in resolution, and the sampling pitch becomes 0.1 mm or less, the grid lead member intervals are required to be very small; 10 or more grid lead members per mm. If the intervals become so small, since the thickness of each lead plate for blocking scattered rays is almost fixed, the areas through which direct rays pass narrow, and the use efficiency of the X-ray dose becomes extremely low. As a consequence, proper imaging operation cannot be performed.

### SUMMARY OF THE INVENTION

It is an object of the present invention to provide an image acquisition method and apparatus which can acquire an image which prevents a stripe pattern originating from a scattered ray removing grid from interfering with observation when X-rays are radiated by using the scattered ray removing grid.

It is another object of the present invention to provide an image acquisition method and apparatus which can remove a stripe pattern, in an image, which originates from a scattered ray removing grid when X-rays are radiated by using the scattered ray removing grid.

According to an aspect of the present invention, there is provided an image acquisition apparatus characterized by comprising a sensor for two-dimensionally sampling a radiation transmission distribution on an object to be imaged at desired sampling intervals, and a scattered ray removing grid for removing scattered rays, which is used without being moved during acquisition of an image by said sensor, wherein intervals of elements of said scattered ray removing grid are set such that a spatial frequency of a stripe pattern, in the image, which originates from said scattered ray removing grid becomes not less than 40% of a sampling frequency that is the reciprocal of the sampling intervals.

It is another aspect of the present invention, there is provided an image acquisition apparatus characterized by comprising a sensor for two-dimensionally sampling a radiation transmission distribution on an object to be imaged at desired sampling intervals, and a scattered ray removing grid for removing scattered rays, which is used without being moved during acquisition of an image by said sensor, wherein intervals of elements of said scattered ray removing grid are set such that a spatial frequency of a stripe pattern, in the image, which originates from said scattered ray removing grid becomes not less than 30% of a sampling frequency that is the reciprocal of the sampling intervals.

According to still another aspect of the present invention, there is provided an image acquisition apparatus characterized by comprising a sensor for two-dimensionally sampling a radiation transmission distribution on an object to be imaged at desired sampling intervals, and a scattered ray removing grid for removing scattered rays, which is used without being moved during acquisition of an image by said sensor, wherein intervals of elements of said scattered ray removing grid are set such that a spatial frequency of a stripe pattern, in the image, which originates from the scattered ray removing grid becomes fs(n+0.3)˜fs(n+0.4) or fs(n+0.6)˜fs(n+0.8) [cyc/mm] where 1/fs [mm] is the desired intervals (fs is an arbitrary positive number) and n is an integer not less than 0.

According to still another aspect of the present invention, there is provided an image acquisition method of radiating radiation by using a scattered ray removing grid without moving the scattered ray removing grid and two-dimensionally sampling a radiation transmission distribution on an object to be imaged at desired sampling intervals, characterized by comprising the step of acquiring an image by setting intervals of elements of the scattered ray removing grid such that a spatial frequency of a stripe pattern, in the image, which originates from the scattered ray removing grid becomes not less than 40% of a sampling frequency that is the reciprocal of the sampling intervals.

According to still another aspect of the present invention, there is provided an image acquisition method of radiating radiation by using a scattered ray removing grid without moving the scattered ray removing grid and two-dimensionally sampling a radiation transmission distribution on an object to be imaged at desired sampling intervals, characterized by comprising the step of acquiring an image by setting intervals of elements of the scattered ray removing grid such that a spatial frequency of a stripe pattern, in the image, which originates from the scattered ray removing grid becomes not less than 30% of a sampling frequency that is the reciprocal of the sampling intervals.

According to still another aspect of the present invention, there is provided an image acquisition method of radiating radiation by using a scattered ray removing grid without moving the scattered ray removing grid and two-dimensionally sampling a radiation transmission distribution on an object to be imaged at desired sampling intervals, characterized by comprising the step of acquiring an image by setting intervals of elements of the scattered ray removing grid such that a spatial frequency of a stripe pattern, in the image, which originates from the scattered ray removing grid becomes fs(n+0.3)˜fs(n+0.4) or fs(n+0.6)˜fs(n+0.8) [cyc/mm] where 1/fs [mm] is the desired intervals (fs is an arbitrary positive number) and n is an integer not less than 0.

According to the present invention, when an X-ray image is two-dimensionally sampled to acquire a digital image, an image that can be observed by the observer with little sense of incongruity without removing a grid stripe pattern from the image can be formed by setting the spatial frequency of a stripe pattern originating from the grid for removing scattered rays from the image to a predetermined value.

According to still another aspect of the present invention, there is provided an image acquisition apparatus characterized by comprising image acquisition means for radiating radiation by using a scattered ray removing grid and acquiring an image by two-dimensionally sampling a radiation transmission distribution on an object to be imaged at desired intervals, image processing means for removing a stripe pattern originating from the scattered ray removing grid from the acquired image by image processing, and selection means for allowing selection between removal and nonremoval of the stripe pattern originating from the scattered ray removing grid by using said image processing means.

According to still another aspect of the present invention, there is provided an image acquisition method characterized by comprising (a) the step of radiating radiation by using a scattered ray removing grid and acquiring an image by two-dimensionally sampling a radiation transmission distribution on an object to be imaged at desired intervals, (b) the step of selecting between removal and nonremoval of a stripe pattern originating from the scattered ray removing grid from the acquired image by image processing, and (c) the step of removing the stripe pattern originating from the scattered ray removing grid by image processing in accordance with the selection.

According to the present invention, since whether to remove a stripe pattern originating from the scattered ray removing grid from an image can be selected, an appropriate image can be obtained by removing the stripe pattern originating from the scattered ray removing grid only when required.

Other objects and advantages besides those discussed above shall be apparent to those skilled in the art from the description of a preferred embodiment of the invention which follows. In the description, reference is made to accompanying drawings, which form a part thereof, and which illustrate an example of the invention. Such example, however, is not exhaustive of the various embodiments of the invention, and therefore reference is made to the claims which follow the description for determining the scope of the invention.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a block diagram for explaining the first embodiment of the present invention;

FIGS. 2A and 2B are graphs for explaining spatial spectra in an image;

FIG. 3 is a flow chart for the implementation of the first embodiment by software;

FIG. 4 is a block diagram for explaining the second embodiment of the present invention;

FIG. 5 is a block diagram for explaining the third embodiment of the present invention;

FIG. 6 is a block diagram for explaining the fourth embodiment of the present invention;

FIGS. 7(1-a) to 7(3-b) are graphs for explaining artifacts originating from a grid stripe pattern;

FIGS. 8A and 8B are graphs for explaining beat noise produced when a grid stripe pattern is sampled;

FIG. 9 is a graph showing an example of the spatial frequency range of a grid body; and

FIG. 10 is a view for explaining a scattered ray removing grid.

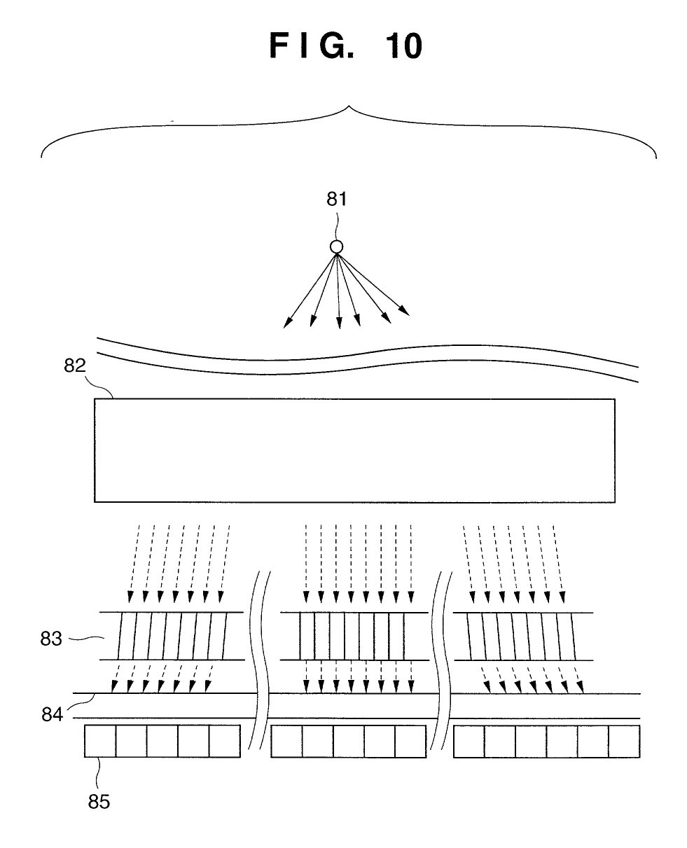

### DETAILED DESCRIPTION OF THE PREFERRED EMBODIMENTS

The embodiments of the present invention will be described below with reference to the accompanying drawings.

(First Embodiment)

In an image acquisition apparatus according to the first embodiment of the present invention, when an acquired image is to be reproduced, the problem in the prior art is solved by setting the intervals of grid lead members such that even if a grid image exists and interferes with an image component to a certain degree, the produced stripes have a frequency which hardly makes an observer have a sense of incongruity.

This embodiment will be described below. In digital images obtained by sampling, image artifacts produced by the grid are classified into the following two categories:

(A) grid images having low spatial frequencies; and

(B) beat images obtained by sampling grid images having low spatial frequencies.

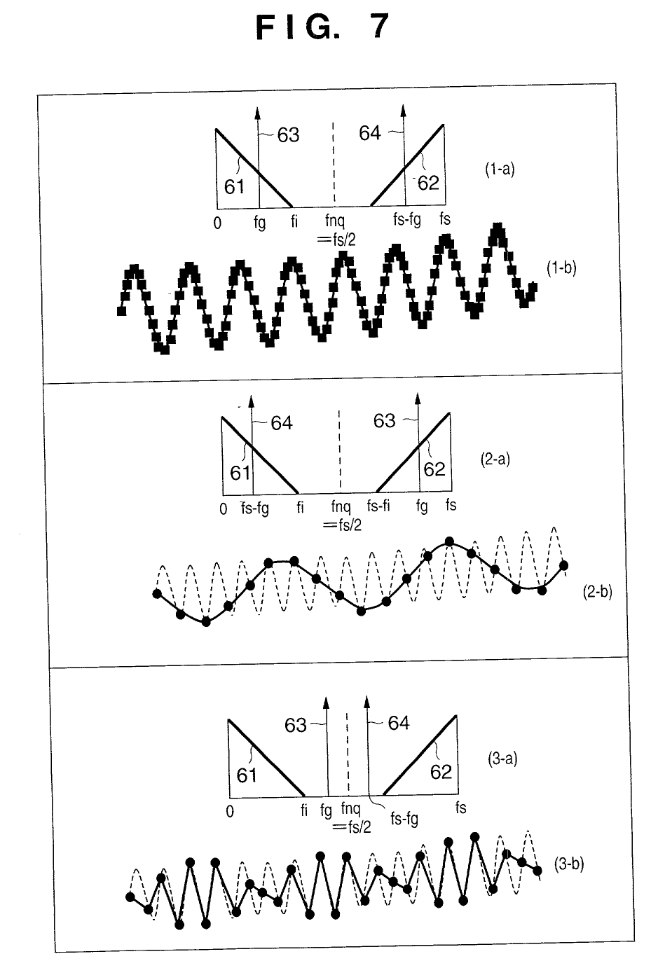

FIGS. 7(1-a) to 7(3-b) schematically show the states of artifacts to explain artifacts belonging to categories (A) and (B). For the sake of descriptive convenience, consider only a fundamental wavelength, assuming that the second- and higher-order harmonics of a grid stripe pattern are not resolved.

FIG. 7(1-a) shows the state of an artifact belonging to category (A) in the frequency domain (only the positive region). Reference numeral 61 denotes an image component region, which exhibits a substantially maximum frequency fi; and 62, an image harmonic component mathematically produced by sampling. In this case, a sampling frequency is represented by fs, and Nyquist frequency fnq=fs/2. A line spectrum 63 is a grid stripe pattern component having a frequency fg. As shown in FIG. 7(1-a), since this component overlaps the image component 61 to impair the image quality, and has a low frequency, the observer experiences a sense of incongruity from the stripe pattern.

FIG. 7(1-b) one-dimensionally shows how sampling is performed. In FIG. (1-b), “●” (bullet) indicates a sampling point.

It is obvious from the above description that the frequency fg of the grid stripe pattern and the frequency fi (fi<fs/2) of the image must satisfy:

fg>fi (1)

FIG. 7(2-a) shows the state of another artifact belonging to category (A) in the frequency domain (only in the positive region). A region 61 is an image component region and exhibits the maximum frequency fi. Since the frequency fg of the grid is higher than the Nyquist frequency fnq that is ½ the sampling frequency fs, a frequency component 64 of fs−fg, which is aliasing, appears. In the case shown in FIG. 7(2-a), the frequency component 64 as aliasing overlaps the image component 61 and impairs the image quality, and hence a stripe pattern gives the observer a sense of incongruity. FIG. 7(2-b) one-dimensionally shows how sampling is performed. In FIG. (2-b), “●” (bullet) indicates a sampling point, and the dashed line indicates a signal form before sampling. That is, to prevent impairment of the image component, the frequency fg of the grid stripe pattern and the frequency fi (fi<fs/2) of the image must satisfy:

fs−fg>fi (2)

According to inequalities (1) and (2), the frequency fg of the grid stripe pattern must satisfy the following inequality, in relation to the maximum frequency fi of the image and the sampling frequency fs:

fi<fg<fs−fi(fi<fs/2) (3)

In this case as well, an artifact belonging to category (B) may be produced.

FIG. 7(3-a) shows a state of an artifact when the grid stripe pattern frequency is set in the spatial frequency region which satisfies inequality (3). FIG. 7(3-b) one-dimensionally shows how sampling is performed. In FIG. (3-b), “●” (bullet) indicates a sampling point, and the dashed line indicates a signal form before sampling.

Referring to FIG. 7(3-a), it seems that since an image frequency component 61 does not overlap a grid image component 63, the image is not impaired, and the observer has no sense of incongruity. If, however, beat noise-like amplitude variation component overlaps a frequency component of image information as shown in FIG. 7(3-b), the observer of the image recognizes this overlap as an artifact, and a stripe pattern gives the observer a sense of incongruity. The frequency of this amplitude variation is given by |fs/2−fg|. When some nonlinear conversion is performed for the image, this variation component may actually become an artifact that impairs the image.

Ideally, all artifact frequencies should fall outside the frequency fi of the image. In this case, no problem arises. Although the frequency fi is the maximum frequency of the image, this frequency may be regarded as a frequency that gives the observer no sense of incongruity when the image is reproduced (hard copy, monitor display, or the like). Both inequality (3) and |fs/2−fg|>fi must be satisfied at once. Assuming that fg is set at a position corresponding to fs>fg>fs/2, the following inequality is established:

fi+fs/2<fg<fs−fi (4)

To satisfy this inequality, fi<fs/4 must also be satisfied, which is a strict condition. If fi<fs/4 is not satisfied in inequality (4), there is no overlap between the ranges defined by the left- and right-side signs. That is, an ideal condition for eliminating the influences of the grid is that the frequency band of the image is equal to or less than ½ the Nyquist frequency, and the frequency of the grid stripe pattern is near ½ the Nyquist frequency. This condition means that if an image to be acquired is determined, the sampling frequency must be set to at least four times higher than the maximum spatial frequency of the image to be acquired.

No consideration, however, is given to the power of beat noise-like variation component. The present inventor has contrived and proven that the condition given by inequality (4) can be moderated, on the basis of the result obtained by comparing the power of the beat noise-like variation component with the power of the grid stripe pattern and the result obtained by observing the image actually formed by using the grid.

As the frequency of the stripe pattern separates farther from the Nyquist frequency, the amplitude variation as beat noise increases in frequency. As a consequence, this component cannot be observed. Consider how much this stripe pattern frequency differs from the Nyquist frequency when it becomes difficult for the observer to observe the variation component.

Line spectra always exist at positions which have a mirror-image relationship centering on the Nyquist frequency whenever sampling is performed, and beat noise is always produced between them. In the cases shown in FIGS. 7(1-b) and 7(2-b), although beat noise is produced, it does not exist apparently. One conceivable reason for this is attributed to frequency; in the case shown in FIG. 7(2-a) or 7(3-a), the distance (frequency) between the two spectra having a mirror-image relationship centering on the Nyquist frequency is large, and hence the beat noise frequency becomes high. At this time, the spectrum of the fundamental sine wave exists sufficiently below the Nyquist frequency, and they greatly differ in frequency and power. For this reason, only the fundamental sine wave having stronger power is strongly recognized by the observer.

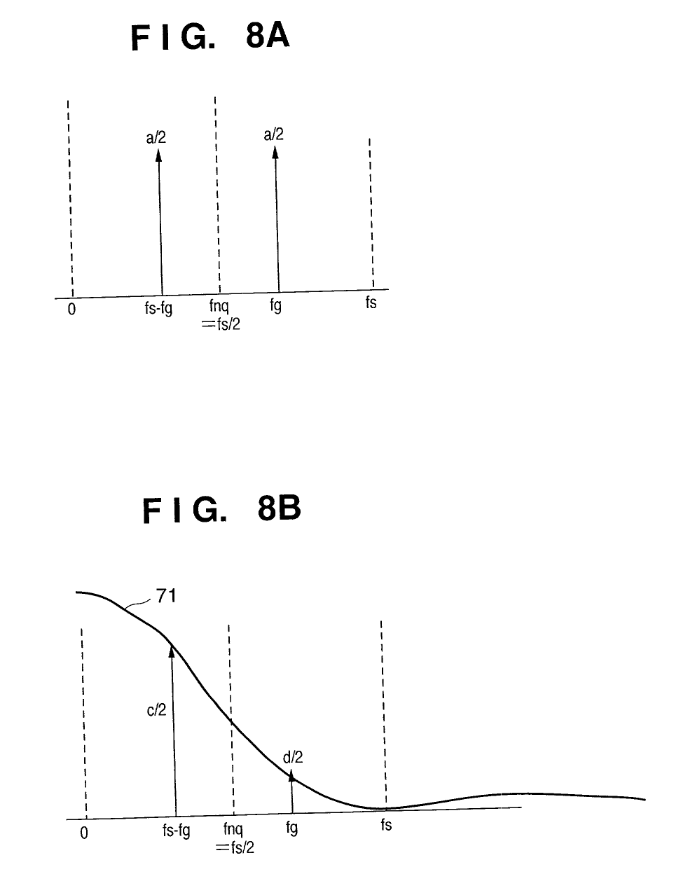

The manner in which beat noise is produced is mathematically expressed. Consider a case wherein a sine wave having the spatial frequency fg is sampled at the sampling frequency fs. Assume that fg>fs/2 is set in consideration of the grid actually used. This is not a necessary condition. In this case, as shown in FIG. 8A, a line spectrum pair corresponding to the frequency of the sine wave is produced. Let a/2 be the peak of each line spectrum, and a ×cos(2πfgx) be the initial grid image. When a cosine wave having the frequency fg is sampled at the frequency fs, two cosine waves appear below fs.

g(x)=a{cos(2πfgx)+cos(2π(fs−fg)x)}

=2a×cos(2π(fg−fs/2)x)×cos(2πfsx/2) (5)

Equation (5) represents beat noise, which is equivalent to the amplitude modulated by a sine wave having a frequency corresponding to the difference between the two sine waves. As (fg/2−fs) becomes a small value other than 0, an unstable amplitude variation (beat) with a low frequency occurs.

According to the Shannon's sampling theorem, data sampled at a frequency equal to or lower than the Nyquist frequency can be completely reconstructed by using an ideal filtering means (a filter that passes signals having frequencies equal to or lower than the Nyquist frequency), and no beat is produced by the line spectrum pair. It is likely that the observer strongly recognizes the beat noise in the case shown in FIG. 7(3-b) because of the filtering means.

In general, a sampled signal is reconstructed by connecting the sampling points with a straight line or the like. This means differs from an ideal filtering means according to the sampling theorem.

A person with normal visual perception or display apparatus interpolates by connecting neighboring points with a straight line without using any ideal filter (convolution using a sinc function as a kernel) as in the sampling theorem. The same applies to a case wherein a signal is observed as an image. That is, such a difference between normal visual perception and the sampling theorem appears as beat noise.

Interpolating with a straight line amounts to filtering with a characteristic like a characteristic curve 71 in FIG. 8B.

According to the characteristic curve 71 in FIG. 8B, a form s(f) of the filter is given by

s(f)=sin²(πf/fs)/(πf/fs)² (6)

Let c/2 and d/2 be the heights of a line spectrum pair at mirror-image positions after filtering.

The sum of sine waves at this time is expressed like equation (5):

g(x)=d×cos(2πfgx)+c×cos(2π(fs×fg)x)

=2d×cos(2π(fg/2−fs)x)×cos(2πfsx/2)+(c−d)×cos(2π(fs−fg)x) (7)

The first term of equation (7) represents beat component; and the second term, a general sine wave component.

According to equation (5), we have

$$c / 2 = ( a / 2 ) \frac{{sin}^{2} ( π fs - \frac{fg}{fs} )}{{( π fs - \frac{fg}{fs} )}^{2}} , d / 2 = ( a / 2 ) \frac{{sin}^{2} ( π \frac{fg}{fs} )}{{( π \frac{fg}{fs} )}^{2}} ( fg > fs ) \qquad ( 8 )$$

If in equation (7) the power of the second term which represents the normal sine wave component exceeds the power of the first term which represents the beat component, it may become difficult for the observer to recognize the beat component.

If the ratio of the power of the first term to that of the second term in equation (7) is calculated on the basis of the above assumption, then (c−d)²/2d²>1 (condition under which the power of the second terminal exceeds that of the first term)

This inequality can be rewritten into

c/d>2^{½}+1

A substitution of this into equation (7) yields

$$\frac{\frac{{sin}^{2} ( π fs - \frac{fg}{fs} )}{{( π fs - \frac{fg}{fs} )}^{2}}}{\frac{{sin}^{2} ( π \frac{fg}{fs} )}{{( π \frac{fg}{fs} )}^{2}}} > \sqrt{2} + 1 , \frac{fg}{fs - fg} > \sqrt{\sqrt{2} + 1} , fg > \frac{fs}{\frac{1}{\sqrt{\sqrt{2} + 1}} + 1} \\ fg > 0.608 fs \qquad ( 9 )$$

It is obvious from inequality (9) that if the frequency of a sine wave to be sampled is higher than 60.8% of a sampling frequency (aliasing occurs), sampling can be performed with little observable beat noise. In this case, grid stripe pattern information appears as a component equal to or less than 80% of the Nyquist frequency (fs/2). This component is equivalent to a component equal to or less than 40% of the sampling frequency. If, therefore, the grid stripe pattern has a frequency equal to or less than 80% of the Nyquist frequency, a stable stripe pattern can be observed without any conspicuous beat upon sampling.

The above consideration defines the upper limit spatial frequency of a stripe pattern (grid stripe pattern) appearing below the Nyquist frequency due to the grid. More specifically, the frequency of the grid stripe pattern is set to be equal to or less than 80% (equal to or less than 40% of the sampling frequency) of the Nyquist frequency. In practice, however, this frequency has its own lower limit. Since an artifact originating from the stripe pattern itself, i.e., stripe pattern information, is not allowed to overlap an image component, the maximum frequency of the image component needs to be lower than the lower limit frequency of the grid stripe pattern.

In general, the maximum frequency component of a signal representing an image cannot be accurately defined. Examples of evaluation criteria for images will be listed below:

A frequency that meets the approval of the observer when an acquired image is reproduced by a display apparatus or recording apparatus.

When a maximum frequency is assumed, the sampling pitch is determined by regarding 1.5 to 2 times the assumed frequency as a maximum frequency (see Nakamizo et al., “Counting/Measurement” (Baihukan)).

The latter condition is widely used, in particular, and the sampling pitch is often set such that a spatial frequency required generally is equal to or less than 60% of the Nyquist frequency (equal to or less than 30% of the sampling frequency). That is, the sampling pitch is set such that grid stripe pattern information appears at a frequency equal to or higher than the sampling frequency.

Assume that the sampling pitch is 0.1 mm (fs=10 cyc/mm). In this case, the Nyquist frequency is 5 cyc/mm. According to the above general condition, the frequency of an image component which is generally used is equal to or less than 30% of the sampling frequency, i.e., 3 cyc/mm. That is, the lower limit frequency of stripe pattern information is 3 cyc/mm, and the upper limit frequency is 40% of the sampling frequency, i.e., 4 cyc/mm. If, therefore, the frequency of a grid stripe pattern is set within the range of 3 to 4 cyc/mm, no conspicuous beat appears in a grid stripe pattern and interferes with observation.

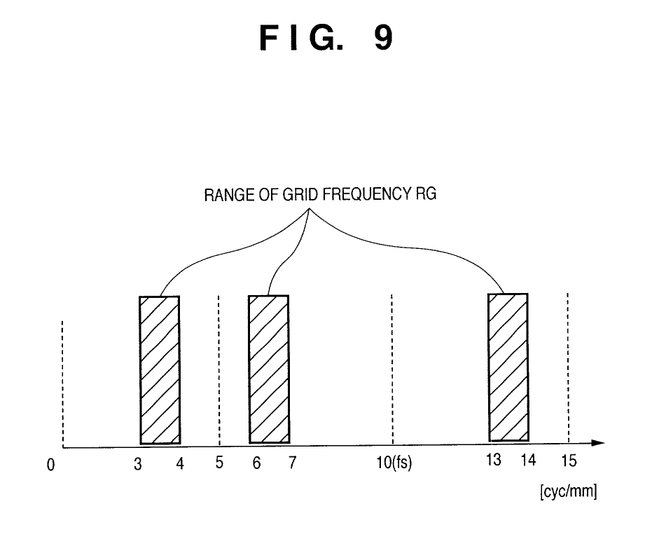

The above condition is set to determine the frequency of a grid stripe pattern, and the frequency of the lead members of the grid body whose stripe pattern corresponds to this value changes after sampling. In this case, as shown in FIG. 9 a frequency range RG [cyc/mm] of the grid body is given by

5(2n+1)−2˜5(2n+1)−1 or 5(2n+1)+1˜(2n+1)+2; n=0, 1, 2, (see FIG. 9)

where n is an integer equal to or more than 0.

This mathematical expression represents a value calculated when the sampling pitch is 0.1 mm (fs=10 cyc/mm). In general, if the sampling frequency fs [cyc/mm] is (sampling pitch 1/fs [mm]), the frequency range of the grid body is given by

fs(n+0.3)˜fs(n+0.4)

or

fs(n+0.6)˜fs(n+0.8)[cyc/mm]

The frequency of the grid body (the number of grid elements) is determined within the above range in consideration of scattered ray removing performance as the primary object of the grid, the resolution of a flat panel sensor, and the like. In general, in consideration of the resolution of the sensor, a grid stripe pattern frequency of 6 to 7 cyc/mm can be selected, at which the second harmonic is difficult to resolve and the scattered ray removing ratio is high.

In this embodiment, the frequency of the grid to be used is selected by the above calculation such that the observer can be satisfied to some degree without removing any grid stripe pattern information owing to some experience or depending on an application purpose, thus overcoming the problem.

As the spatial frequency of the grid stripe pattern is fixed, the grid stripe pattern information can be removed to some extent by filtering. In removing the grid stripe pattern information by setting a grid stripe pattern frequency in the above manner, even if the pattern information cannot be completely removed, reducing the intensity of the grid stripe pattern will minimize the influence on the observer.

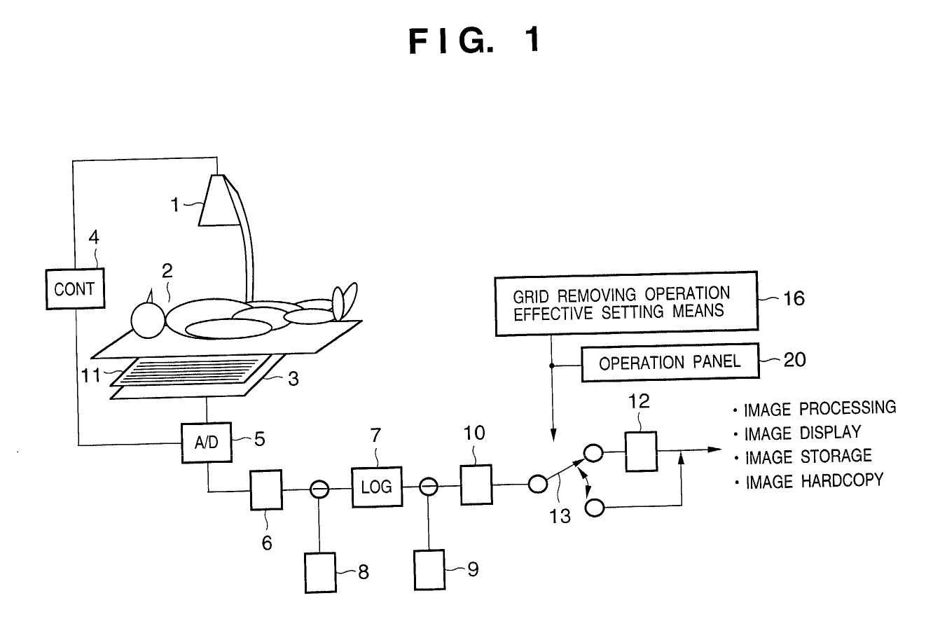

FIG. 1 is a schematic view of the first embodiment. FIG. 1 shows a system for imaging the human body lying on a table. Reference numeral 1 denotes an X-ray tube; 2, a human body as an object to be imaged; 11, a grid for removing scattered X-rays, which is a detachable grid for removing scattered X-rays from the object 2; 3, an X-ray sensor panel for converting an X-ray intensity distribution (X-ray transmission distribution) into a charge distribution, two-dimensionally sampling the distribution at desired intervals, and sequentially outputting the sampled data; 5, an analog/digital converter; 4, a controller for controlling the X-ray radiation timing and image acquisition timing; and 6, a memory for temporarily storing an image. The X-ray sensor panel 3 varies in offset and gain for each pixel. To correct this variation, an offset value as an image acquired without any radiation of X-rays is stored in a memory 8, whereas data obtained by logarithmically converting a gain value acquired without the object 2 and grid 11 is stored in a memory 9. Reference numeral 7 denotes a conversion unit for logarithmic conversion, and more specifically, a lookup table. An acquired image of the human body is logarithmically converted after the offset value in the memory 8 is subtracted (removed) from the image. The difference between the resultant value and the gain value in the memory 9 is calculated (division) to obtain an X-ray intensity distribution image having undergone correction of a variation in gain value. This image is temporarily stored in a memory 10. Thereafter, the stored image is extracted and subjected to image storage, image processing, image display, and hardcopy operation, and the like to be used for diagnosis and the like.

A block 12 is an image processing means (filtering means) for removing grid stripe pattern information by image processing (filtering). The image processing means 12 removes a grid stripe pattern component by spatial filtering using the image stored in the memory 10. A mechanism 13 is a selection means (switch) that is operated by the operator to choose between using the filtering means 12 or not using it in accordance with an output from an external output from a grid removing operation effective setting means (mechanism) 16 or operation panel 20. The flow of a signal can be changed to skip the operation of the block 12 in accordance with the selection made through the selection means 13.

In this case, the X-ray sensor panel 3 has a plurality of pixels distributed vertically and horizontally at a pitch of 0.1 mm in a two-dimensional space. With this structure, two-dimensional, discrete sampling is performed. As described in relation to the setting of the above grid stripe pattern frequency, the grid stripe pattern frequency (the number of grid elements) of the grid 11 is set to 6 to 7 cyc/mm, and hence the observer can observe an image without a sense of incongruity even if the grid tripe pattern information is not removed by filtering.

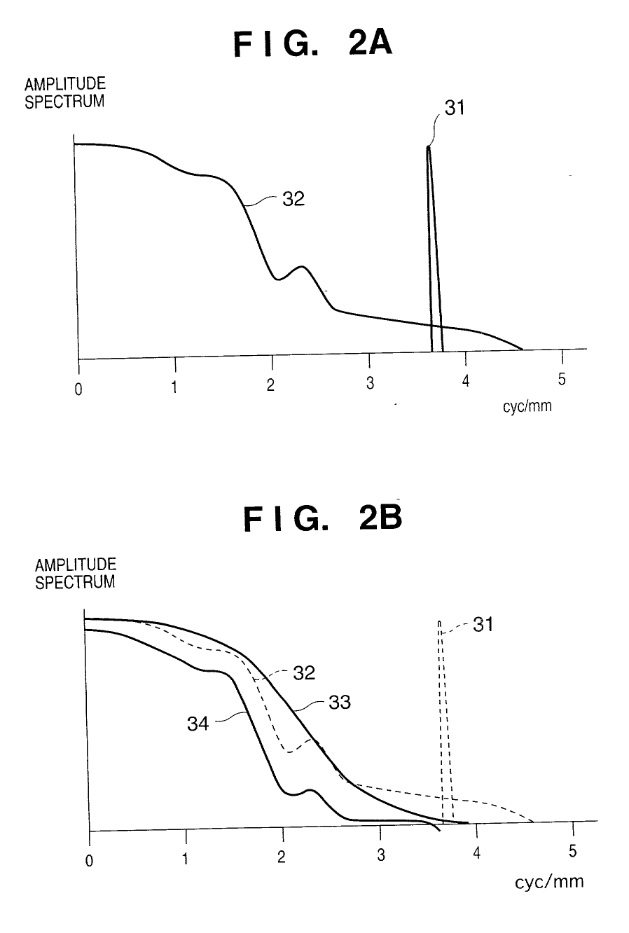

FIG. 2A schematically shows the state of a one-dimensional amplitude spectrum in a direction perpendicular to the grid stripe pattern of the image stored in the memory 10. Referring to FIG. 2A, reference numeral 32 denotes a spectrum of an image component; and 31, a spectrum of a grid stripe pattern component, which exhibits a substantial spectrum form with noise being neglected. Even if the grid stripe pattern component 31 exists, the observer observes only this stable frequency component, and there is no component associated with beat noise. Therefore, as the observer becomes accustomed to the stripe pattern or recognizes it, the existence of the stripe pattern does not relatively interfere with the observation.

If, however, the operator or observer wants to remove the grid stripe pattern information from this image owing to subsequent image processing or the image reproducing mechanism, he/she selects grid removing operation through the operation panel 20.

FIG. 2B schematically shows the state of a spectrum upon execution of grid removing filtering. Reference numeral 33 denotes an example of a filter characteristic; and 34, an image spectrum after filtering. To stabilize spatial characteristics, the filter cannot have a steep characteristic. If, therefore, the grid stripe pattern component 31 is removed, part of an image component inevitably deteriorates in response characteristic. In consideration of this, the operator chooses between removal and nonremoval of the grid. In this embodiment, when the acquired image exhibits the gain value stored in the memory 9, no problem arises if the image is acquired without removing the grid 11 because the frequency of the grid is constant.

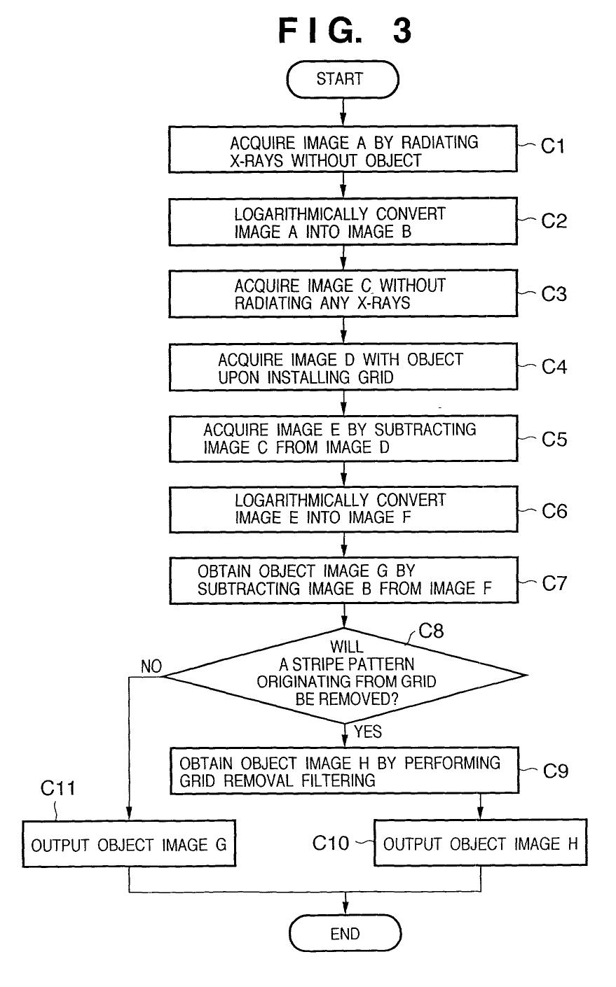

FIG. 3 is a flow chart for the implementation of this embodiment by means of software. Referring to FIG. 3, a process block (step) is divided into operations in blocks C1 to C11. The operation in block C1 is executed to acquire an image of a gain value. An image A is obtained by radiating X-rays without any object. In block C2, this image is logarithmically converted into an image B. In block C3, an offset value is obtained; an image C is obtained without radiating any X-rays. In block C4, an image of the object is actually acquired; the grid is installed, and an image D is obtained by irradiating the object with X-rays. In block C5, the image C is subtracted from the image D to obtain an image E having undergone offset correction. In block C6, the image E is logarithmically converted into an image F. In block C7, the image B is subtracted from the image F to obtain an object image G having undergone gain correction. In block C8, the flow branches depending on whether a stripe pattern operating from grid will be removed in accordance with operation (instruction) of the operation panel 20 by the operator. In block C9, since the instruction to remove the grid is received, filtering, i.e., grid removing operation, is performed for the image G to obtain an object image H from which grid stripe pattern information is removed. In block C10, the object image H is output. If no grid removing instruction is received, the object image G is output without any processing in block C11.

In this embodiment, as the memory means 10 in FIG. 1, a nonvolatile storage medium such as a magnetic disk may be used to always store image data including grid stripe pattern information to allow the operator to select an image without any grid stripe pattern information or an image with grid stripe pattern information or output them at once. Furthermore, this embodiment can be practiced with an arrangement including only an image storage system without any image acquisition system.

(Second Embodiment)

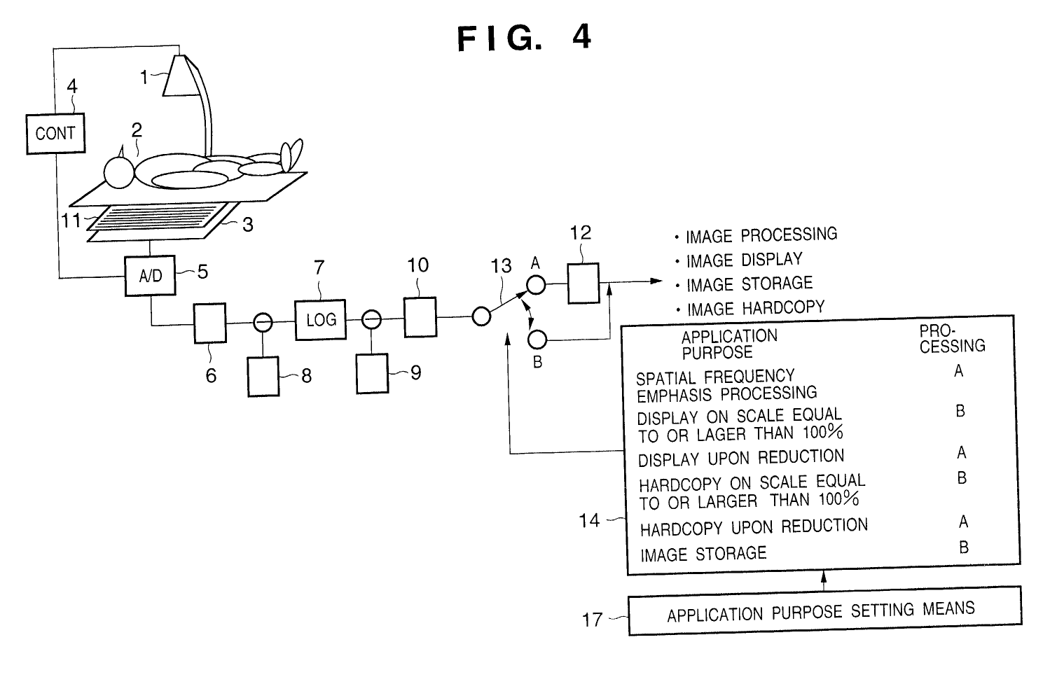

FIG. 4 is a block diagram showing the second embodiment, in which the frequency of a grid stripe pattern, the sampling pitch of an X-ray sensor panel, and the like are set in the same manner as in FIG. 1. In the structure shown in FIG. 4, an application purpose table 14 is prepared. After an image is acquired, the operator selects an application purpose through an application purpose setting means 17 with respect to the image stored in a memory 10 or magnetic disk. As a consequence, whether to remove the grid or not is automatically selected. If a switch 13 selects the A side, the image in the memory 10 is filtered by a filtering unit 12 and output. If the switch 13 selects the B side, the image in the memory 10 is output without being filtered.

As described in relation to the setting of the above grid stripe pattern frequency, the grid stripe pattern frequency (the number of grid elements) of a grid 11 is set to 6 to 7 cyc/mm, and hence the observer can observe an image without a sense of incongruity even if the grid tripe pattern information is not removed by filtering.

With this table 14, for example, in emphasizing a high spatial frequency as in spatial frequency emphasis processing, since a grid image becomes a hindrance, it is removed (the switch 13 is set on the A side). In displaying an image or performing hardcopy operation on a larger scale, i.e., 100% or more, the switch 13 is set on the B side to inhibit removal of a grid image so as to minimize an image blur. In displaying an image or performing hardcopy operation upon reduction, the switch 13 is set on the A side to remove a grid image. If an image is to be stored in another storage means, since removal processing can be performed for the stored image, the switch 13 is set on the B side to inhibit removal of a grid image, thus increasing the information amount.

(Third Embodiment)

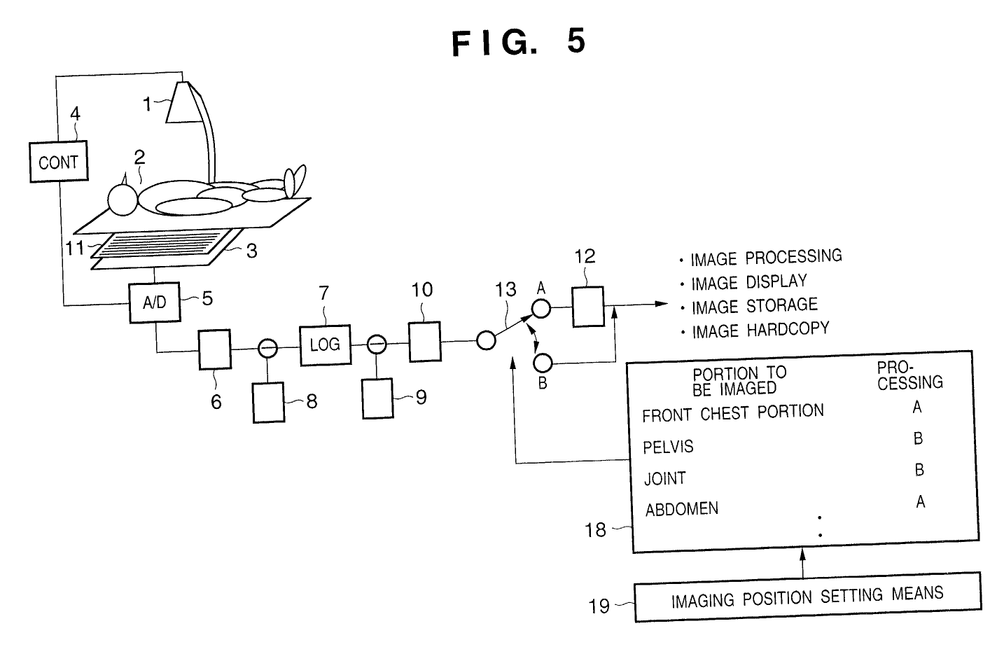

FIG. 5 is a block diagram showing the third embodiment, in which the frequency of a grid stripe pattern, the sampling pitch of an X-ray sensor panel, and the like are set in the same manner as in FIG. 1. In the structure shown in FIG. 5, an imaging position table 18 is prepared. When the operator selects an application purpose through an imaging position setting means 19 with respect to the image stored in a memory 10 or magnetic dick upon imaging operation, whether to perform grid removing operation or not is automatically selected.

As described in relation to the setting of the above grid stripe pattern frequency, the grid stripe pattern frequency (the number of grid elements) of a grid 11 is set to 6 to 7 cyc/mm, and hence the observer can observe an image without a sense of incongruity even if the grid tripe pattern information is not removed by filtering.

With this table 18, when the observer is to observe an image of a bone portion such as the pelvis or joint, which requires a high spatial frequency for the image, a switch 13 is set on the B side to allow the observer to observe the image without any blur without removing a grid image. When the observer is to observe a chest portion (front chest portion), abdomen, or the like for which a high spatial frequency is not required, and a halftone image needs to be easily observed, the switch 13 is set on the A side to allow the observer to observe the image without any grid image.

(Fourth Embodiment)

Although the grid frequency is so set that a grid image does not relatively interfere with observation, if the contrast of the grid image is strong, it still interferes with the observer. The contrast of a grid image varies depending on the conditions (e.g., energy) of X-rays to be used. In some case, an object is imaged without any grid.

To determine this, the spectrum of a given portion of an acquired image in a direction perpendicular to the grid is calculated, and whether to perform grid removing operation or not is selected depending on the peak value of the grid component (directly corresponding to the contrast value if it is a logarithmic image).

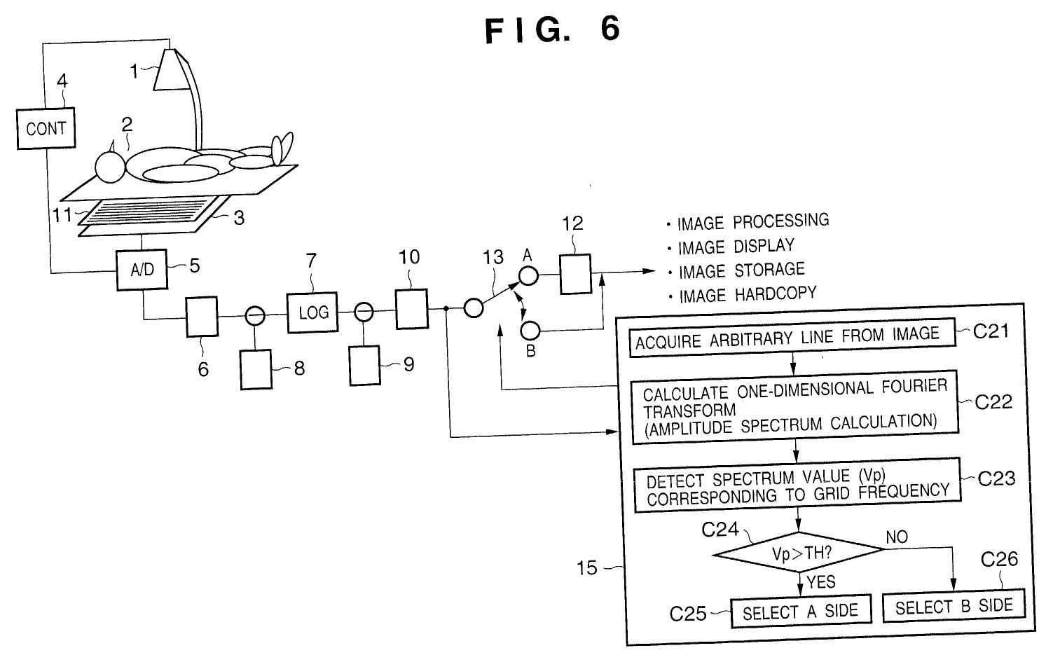

FIG. 6 is a block diagram showing the fourth embodiment, in which the frequency of a grid stripe pattern, the sampling pitch of an X-ray sensor panel, and the like are set in the same manner as in FIG. 1. As described in relation to the setting of the above grid stripe pattern frequency, the grid stripe pattern frequency (the number of grid elements) of a grid 11 is set to 6 to 7 cyc/mm, and hence the observer can observe an image without a sense of incongruity even if the grid tripe pattern information is not removed by filtering.

A block 15 in FIG. 6 includes software; a flow chart is shown in the block. In block C21 in the flow chart, an arbitrary line is acquired from an image from a memory 10. In block C22, one-dimensional Fourier transformation is performed for this image to calculate an amplitude spectrum. In block C23, an amplitude value (spectrum value) Vp corresponding to the grid frequency is measured from the amplitude spectrum value. In block C24, the amplitude value Vp is compared with a threshold TH set in advance. If Vp is larger than TH, the corresponding grid image must be removed. To remove the grid image, therefore, a switch 13 is set on the A side in block C25. If Vp is not larger than TH, the switch 13 is set on the B side in block C26.

Note that the switch 13 may be selectively operated in accordance with the magnitude of contrast of a grid stripe pattern existing at the grid frequency. If the contrast is higher than a predetermined threshold, the switch 13 is set on the A side to remove a grid image. If the contrast is lower than the predetermined threshold, the switch 13 is set on the B side to inhibit the removal of a grid image.

As described above, according to this embodiment, in a system for two-dimensionally sampling an X-ray image and forming a digital image, an image that can be observed by the observer with little sense of incongruity without removing a grid stripe pattern from the image can be formed by setting the frequency of the grid lead members to be equal to or lower than 40% of the sampling frequency at which the spatial frequency of a stripe image originating from the grid for removing scattered rays from the image and equal to or higher than the frequency (60% of the Nyquist frequency in general) at which a grid image does not easily interfere with observation of the image by the observer and does not overlap an image component.

In addition, the filtering means 12 can choose between removal or nonremoval of a grid stripe pattern in accordance with selection through the switch 13. Since a grid stripe pattern is automatically removed in accordance with operation by the operator (observer), the application purpose of an image, imaging position, and the amplitude (intensity) of a grid stripe pattern, an appropriate image can be obtained by removing a grid stripe pattern only when required.

Each embodiment described above is merely an example in practicing the present invention. Note that the technical scope of the present invention should not be interpreted in a limited manner. That is, the present invention can be practiced in various forms without departing from the spirit and scope of the present invention.

As has been described above, according to each embodiment described above, when an X-ray image is two-dimensionally sampled to acquire a digital image, an image that can be observed by the observer with little sense of incongruity without removing a grid stripe pattern from the image can be formed by setting the spatial frequency of a stripe pattern originating from the grid for removing scattered rays from the image to a predetermined value.

In addition, since whether to remove a stripe pattern originating from the scattered ray removing grid from an image can be selected, an appropriate image can be obtained by removing a stripe pattern originating from the scattered ray removing grid.

The present invention is not limited to the above embodiments and various changes and modifications can be made within the spirit and scope of the present invention. Therefore, to apprise the public of the scope of the present invention the following claims are made.

What is claimed is:

1. An image acquisition apparatus, comprising:
a sensor for two-dimensionally sampling a radiation transmission distribution on an object to be imaged at desired sampling intervals; and
a scattered ray removing grid for removing scattered rays, which is used without being moved during acquisition of an image by said sensor,
wherein intervals of elements of said scattered ray removing grid are set such that a spatial frequency of a stripe pattern, in the image, which originates from said scattered ray removing grid becomes not less than 40% of a sampling frequency that is the reciprocal of the sampling intervals.

2. The apparatus according to claim 1, wherein the spatial frequency of the stripe pattern originating from the scattered ray removing grid is not less than 30% of the sampling frequency.

3. An image acquisition apparatus, comprising:
a sensor for two-dimensionally sampling a radiation transmission distribution on an object to be imaged at desired sampling intervals; and
a scattered ray removing grid for removing scattered rays, which is used without being moved during acquisition of an image by said sensor,
wherein intervals of elements of said scattered ray removing grid are set such that a spatial frequency of a stripe pattern, in the image, which originates from said scattered ray removing grid becomes not less than 30% of a sampling frequency that is the reciprocal of the sampling intervals.

4. An image acquisition apparatus, comprising:
a sensor for two-dimensionally sampling a radiation transmission distribution on an object to be imaged at desired sampling intervals; and
a scattered ray removing grid for removing scattered rays, which is used without being moved during acquisition of an image by said sensor,
wherein intervals of elements of said scattered ray removing grid are set such that a spatial frequency of a stripe pattern, in the image, which originates from the scattered ray removing grid becomes fs(n+0.3)˜fs(n+0.4) or fs(n+0.6)˜fs(n+0.8) [cyc/mm] where 1/fs [mm] is the desired intervals (fs is an arbitrary positive number) and n is an integer not less than 0.

5. The apparatus according to claim 4, wherein the intervals of the elements of the scattered ray removing grid are set such that the spatial frequency of the stripe pattern becomes 6 to 7 [cyc/mm].

6. The apparatus according to claim 4, wherein the intervals of the elements of the scattered ray removing grid are set such that the spatial frequency of the stripe pattern becomes 3 to 4 [cyc/mm].

7. The apparatus according to claim 1, further comprising offset value removing means for removing an offset value from the image acquired by radiating the radiation.

8. The apparatus according to claim 7, wherein said offset value removing means includes first subtraction means, as a method of practicing claim 7, for subtracting an image acquired without radiating radiation from the image acquired by radiating the radiation.

9. The apparatus according to claim 1, further comprising gain value correction means for correcting a variation in gain value with respect to the acquired image.

10. The apparatus according to claim 9, wherein said gain value correction means includes division means for dividing the acquired image by an image acquired without the object.

11. The apparatus according to claim 9, wherein said gain value correction means includes second subtraction means for subtracting an image obtained by logarithmically converting an image acquired without the object from an image obtained by logarithmically converting the acquired image.

12. The apparatus according to claim 1, further comprising filtering means for removing a stripe pattern, in the image, which originates from the scattered ray removing grid by filtering the acquired image.

13. The apparatus according to claim 12, wherein said filtering means performs filtering in accordance with operation performed by an operator.

14. The apparatus according to claim 12, wherein said filtering means performs filtering in accordance with an application purpose of an image.

15. The apparatus according to claim 14, wherein said filtering means performs filtering if the purpose is to perform spatial frequency emphasis processing for an image.

16. The apparatus according to claim 14, wherein said filtering means performs no filtering if the purpose is to display an image or perform hardcopy operation on a scale not less than 100% or hardcopy operation.

17. The apparatus according to claim 14, wherein said filtering means performs filtering if the purpose is to display an image or perform hardcopy operation upon reduction of the image.

18. The apparatus according to claim 14, wherein said filtering means performs no filtering if the purpose is to store an image.

19. The apparatus according to claim 12, wherein said filtering means performs filtering in accordance with an imaging position.

20. The apparatus according to claim 19, wherein said filtering means performs no filtering if the imaging position is a bone portion.

21. The apparatus according to claim 19, wherein said filtering means performs no filtering if the imaging position is a pelvis or joint.

22. The apparatus according to claim 19, wherein said filtering means performs filtering if the imaging position is a chest portion or abdominal portion.

23. The apparatus according to claim 12, wherein said filtering means performs filtering in accordance with a magnitude of an amplitude of a frequency of a stripe pattern originating from the scattered ray removing grid.

24. The apparatus according to claim 12, wherein said filtering means performs filtering if the amplitude of the frequency of the stripe pattern originating from the scattered ray removing grid is larger than a predetermined threshold.

25. An image acquisition method of radiating radiation by using a scattered ray removing grid without moving the scattered ray removing grid and two-dimensionally sampling a radiation transmission distribution on an object to be imaged at desired sampling intervals, comprising
the step of acquiring an image by setting intervals of elements of the scattered ray removing grid such that a spatial frequency of a stripe pattern, in the image, which originates from the scattered ray removing grid becomes not less than 40% of a sampling frequency that is the reciprocal of the sampling intervals.

26. An image acquisition method of radiating radiation by using a scattered ray removing grid without moving the scattered ray removing grid and two-dimensionally sampling a radiation transmission distribution on an object to be imaged at desired sampling intervals, comprising
the step of acquiring an image by setting intervals of elements of the scattered ray removing grid such that a spatial frequency of a stripe pattern, in the image, which originates from the scattered ray removing grid becomes not less than 30% of a sampling frequency that is the reciprocal of the sampling intervals.

27. An image acquisition method of radiating radiation by using a scattered ray removing grid without moving the scattered ray removing grid and two-dimensionally sampling a radiation transmission distribution on an object to be imaged at desired sampling intervals, comprising
the step of acquiring an image by setting intervals of elements of the scattered ray removing grid such that a spatial frequency of a stripe pattern, in the image, which originates from the scattered ray removing grid becomes fs(n+0.3)˜fs(n+0.4) or fs(n+0.6)˜fs(n+0.8) [cyc/mm] where 1/fs [mm] is the desired intervals (fs is an arbitrary positive number) and n is an integer not less than 0.

28. An image acquisition apparatus, comprising:
image acquisition means for radiating radiation by using a scattered ray removing grid and acquiring an image by two-dimensionally sampling a radiation transmission distribution on an object to be imaged at desired intervals;
image processing means for removing a stripe pattern originating from the scattered ray removing grid from the acquired image by image processing; and
selection means for allowing selection between removal and nonremoval of the stripe pattern originating from the scattered ray removing grid by using said image processing means.

29. The apparatus according to claim 28, wherein said image processing means removes the stripe pattern originating from the scattered ray removing grid by filtering.

30. The apparatus according to claim 28, wherein said selection means selects between removing the stripe pattern or not removing the stripe pattern in accordance with operation performed by an operator.

31. The apparatus according to claim 28, wherein said selection means selects between removing the stripe pattern or not removing the stripe pattern in accordance with an application purpose of an image.

32. The apparatus according to claim 31, wherein said selection means selects removing the stripe pattern if the purpose is to perform spatial frequency emphasis processing for an image.

33. The apparatus according to claim 31, wherein said selection means selects not removing the stripe pattern if the purpose is to display an image or perform hardcopy operation on a scale not less than 100% or hardcopy operation.

34. The apparatus according to claim 31, wherein said selection means selects removing the stripe pattern if the purpose is to display an image or perform hardcopy operation upon reduction of the image.

35. The apparatus according to claim 31, wherein said selection means selects not removing the stripe pattern if the purpose is to store an image.

36. The apparatus according to claim 28, wherein said selection means selects between removing the stripe pattern or not removing the stripe pattern in accordance with an imaging position.

37. The apparatus according to claim 36, wherein said selection means selects not removing the stripe pattern if the imaging position is a bone portion.

38. The apparatus according to claim 36, wherein said selection means selects not removing the stripe pattern if the imaging position is a pelvis or joint.

39. The apparatus according to claim 36, wherein said selection means selects removing the stripe pattern if the imaging position is a chest portion or abdominal portion.

40. The apparatus according to claim 28, wherein selection means selects between removing the stripe pattern and not removing the stripe pattern in accordance with a magnitude of an amplitude of a frequency of a stripe pattern originating from the scattered ray removing grid.

41. The apparatus according to claim 40, wherein said selection means selects removing the stripe pattern if the amplitude of the frequency of the stripe pattern originating from the scattered ray removing grid is larger than a predetermined threshold.

42. The apparatus according to claim 28, wherein said selection means selects between removal or nonremoval of the stripe pattern in accordance with a magnitude of contrast of the stripe pattern originating from the scattered ray removing grid.

43. The apparatus according to claim 28, further comprising offset value removing means for removing an offset value from the image acquired by radiating the radiation.

44. The apparatus according to claim 43, wherein said offset value removing means includes first subtraction means for subtracting an image acquired without radiating radiation from the image acquired by radiating the radiation.

45. The apparatus according to claim 28, further comprising gain value correction means for correcting a variation in gain value with respect to the acquired image.

46. The apparatus according to claim 45, wherein said gain value correction means includes division means, as a method of implementing claim 45, which divides the acquired image by an image acquired without the object.

47. The apparatus according to claim 45, wherein said gain value correction means includes second subtraction means for subtracting an image obtained by logarithmically converting an image acquired without the object from an image obtained by logarithmically converting the acquired image.

48. An image acquisition method, comprising:
(a) the step of radiating radiation by using a scattered ray removing grid and acquiring an image by two-dimensionally sampling a radiation transmission distribution on an object to be imaged at desired intervals;
(b) the step of selecting between removal and nonremoval of a stripe pattern originating from the scattered ray removing grid from the acquired image by image processing; and
(c) the step of removing the stripe pattern originating from the scattered ray removing grid by image processing in accordance with the selection.

49. The apparatus according to claim 28, wherein
the scattered ray removing grid is used without being moved, and
said image acquisition means acquires an image by setting intervals of elements of the scattered ray removing grid such that a spatial frequency of a stripe pattern, in the image, which originates from the scattered ray removing grid becomes not less than 40% of a sampling frequency that is the reciprocal of the sampling intervals.

50. The apparatus according to claim 28, wherein
the scattered ray removing grid is used without being moved, and
said image acquisition means acquires an image by setting intervals of elements of the scattered ray removing grid such that a spatial frequency of a stripe pattern, in the image, which originates from the scattered ray removing grid becomes not less than 30% of a sampling frequency that is the reciprocal of the sampling intervals.

51. The apparatus according to claim 28, wherein
the scattered ray removing grid is used without being moved, and
said image acquisition means acquires an image by setting intervals of elements of the scattered ray removing grid such that a spatial frequency of a stripe pattern, in the image, which originates from the scattered ray removing grid becomes fs(n+0.3)˜fs(n+0.4) or fs(n+0.6)˜fs(n+0.8) [cyc/mm] where 1/fs [mm] is the desired intervals (fs is an arbitrary positive number) and n is an integer not less than 0.

52. The method according to claim 48, wherein
the scattered ray removing grid is used without being moved, and
the image acquisition step comprises acquiring an image by setting intervals of elements of the scattered ray removing grid such that a spatial frequency of a stripe pattern, in the image, which originates from the scattered ray removing grid becomes not less than 40% of a sampling frequency that is the reciprocal of the sampling intervals.

53. The method according to claim 48, wherein
the scattered ray removing grid is used without being moved, and
the image acquisition step comprises acquiring an image by setting intervals of elements of the scattered ray removing grid such that a spatial frequency of a stripe pattern, in the image, which originates from the scattered ray removing grid becomes not less than 30% of a sampling frequency that is the reciprocal of the sampling intervals.

54. The method according to claim 48, wherein
the scattered ray removing grid is used without being moved, and
the image acquisition step comprises acquiring an image by setting intervals of elements of the scattered ray removing grid such that a spatial frequency of a stripe pattern, in the image, which originates from the scattered ray removing grid becomes fs(n+0.3)˜fs(n+0.4) or fs(n+0.6)˜fs(n+0.8) [cyc/mm] where 1/fs [mm] is the desired intervals (fs is an arbitrary positive number) and n is an integer not less than 0.
